(19) United States
(12) Patent Application Publication
(10) Pub. No.: US 2020/0352134 A1
(43) Pub. Date: Nov. 12, 2020

(54) METHOD AND DEVICE FOR RAISING JUVENILE FARM ANIMALS

(71) Applicant: MimicTec Pty Ltd, Melbourne (AU)

(72) Inventor: Sarah Last, Melbourne (AU)

(21) Appl. No.: 16/965,664

(22) PCT Filed: Nov. 30, 2018
(86) PCT No.: PCT/AU2018/051288

§ 371 Date: Jul. 29, 2020

(30) Foreign Application Priority Data
Jan. 31, 2018 (AU) 2018900295

(51) Int. Cl. A01K 15/02; A01K 5/00; A01K 7/00

(52) U.S. Cl. CPC A01K 15/02; A01K 5/00; F21V 23/0407; A01K 15/028; A01K 7/00

(57) ABSTRACT

A system for increasing feed/drink attempts made by juvenile animals during an early period of life of the juvenile animals includes: at least one visual stimulus, the at least one visual stimulus including a neck member being attachable to a component of the system such that the neck member is movable with respect to the component, the neck member having an indicating portion for indicating a location of at least one feed/drink source. In operation, the indicating portion repeatedly alternates between a movement toward and a movement away from the location of the at least one feed/drink source.

### CROSS-REFERENCE TO PRIOR APPLICATIONS

This application is a U.S. National Phase application under 35 U.S.C. § 371 of International Application No. PCT/AU2018/051288, filed on Nov. 30, 2018, and claims benefit to Australian Patent Application Publication No. AU 2018/900295, filed on Jan. 31, 2018. The International Application was published in English on Aug. 8, 2019 as WO 2019/148232 under PCT Article 21(2).

### FIELD

Embodiments relate generally to systems, methods and apparatus raising juvenile farm animals. Some embodiments relate to encouraging juvenile farm animals to feed or drink from one or more selected locations. Some embodiments relate to a method of raising juvenile farm animals to enhance welfare of juvenile farm animals in the absence of natural maternal care.

### BACKGROUND

According to the Australian productivity commission, farmers need to double the efficiency on farms every generation in order to remain financially viable. Additionally, the global consumption of meat is set to grow by an annual average of 1.4% over the next decade, adding to the need for efficiency improvements within livestock production systems. As such, reducing inefficiencies on farms is vital for both financial and environmental sustainability of the agriculture sector.

A significant early source of stress in commercial animal production is the separation of juvenile precocial farm animals from their mothers. When farm animals are raised with natural maternal care, they show fewer signs of distress and score better in productivity metrics compared to those raised without maternal care. It is not always possible to raise juvenile precocial farm animals using a natural maternal figure for reasons including biosecurity, space constraints and other logistical concerns.

Typically poultry, such as chickens, are hatched in large batch sizes before being moved to a grow-out facility such as a cage system, barn or in a free range environment. These batch sizes can sometimes be up to 100 000 chicks per shed. If each hen were to raise her own chicks, there would be an additional 4000 full sized chickens that would need to be fed and housed. In a dairy farm, calves are typically separated from the cow shortly after birth so that the cow's milk can be harvested and the nutritional plane of the calf can be monitored. In swine production, sows are allowed to be in contact with the juvenile to feed them but are kept in farrowing crates or sow stalls to prevent overlay of the piglets. Whilst this is done for biosecurity and space saving reasons, a number of animal models have significant and long lasting impacts on the welfare of the animals involved. For example, in some cases, in the absence of a natural maternal figure, the juvenile animals may take longer to learn appropriate eating and drinking behaviour, and may be malnourished.

It is desired to address or ameliorate one or more shortcomings or disadvantages associated with existing apparatus or methods for animal production, or to at least provide a useful alternative.

### SUMMARY

In an embodiment, the present invention provides a system for increasing feed/drink attempts made by juvenile animals during an early period of life of the juvenile animals, comprising: at least one visual stimulus, the at least one visual stimulus including a neck member being attachable to a component of the system such that the neck member is movable with respect to the component, the neck member having an indicating portion configured to indicate a location of at least one feed/drink source, wherein, in operation, the indicating portion repeatedly alternates between a movement toward and a movement away from the location of the at least one feed/drink source.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic diagram of an apparatus according to some embodiments;

FIG. 2 is a perspective view of a mechanical device according to some embodiments;

FIG. 3A is a perspective view of the device of FIG. 2 coupled to a water line, according to some embodiments;

FIG. 3B is a perspective view of a plurality of devices of FIG. 4 coupled to water lines in a farm, according to some embodiments;

FIG. 4 is a perspective view of another mechanical device according to some embodiments;

FIG. 5 is a perspective view of another mechanical device coupled to a food outlet, according to some embodiments;

FIG. 6 is a perspective view of components of auditory and visual systems mounted on a food outlet, according to some embodiments; and

FIG. 7 is a perspective view of a mechanical device according to other embodiments.

### DETAILED DESCRIPTION

One of the key aspects of maternal care is the specific set of behaviors and vocalization patterns that natural maternal figures use to teach juvenile animals what food and water is, how to eat/drink and to direct juvenile animals to eat/drink at appropriate times. These behaviours and vocalisation patterns, collectively termed here “directive feeding behaviour” are not present when maternal figures are removed from juvenile animals. In many animal production systems the productivity and welfare of the animal is reduced as a result of the absence of directive feeding behaviours.

Research was undertaken to mimic features generally observed between a juvenile farm animal and its natural maternal figure in order to enhance welfare of a juvenile animal separated at birth. It has been found that by mimicking certain characteristics of natural auditory and/or visual stimuli, some juvenile animals can be encouraged to move towards a particular desired location. Such stimuli may be used to encourage juvenile farm animals to eat and/or drink at appropriate times, which may in turn lead to an increased body weight, increased survival rate, and/or improved health and welfare of the juvenile animals.

In the case of chicks, and other juvenile ground fowl, there is little connection between their gastrointestinal tracts and their brains during the first few days of life. The chicks do not recognise whether they are eating food and drinking water, or whether they are consuming some other non-nutrient substance and thus can be equally satisfied by non-food materials during this time. Accordingly, the chicks can be not only harmed by consuming non-food materials, but also undernourished. However, during this period of life, chicks do have an inherent non-learnt ability to respond through activation or engagement (as defined above) to specific stimuli. This non-learnt response deteriorates after the first four days, after which the neural connection between the gastrointestinal tract and the brain of the chick has developed. Therefore, exposure to such stimuli at a very early stage is critical. The inventor has found that, especially in the first 24 hours of life, increased feed and water intake can reduce mortalities.

According to a first aspect of the present invention, there is provided a system for increasing feed/drink attempts made by juvenile animals during an early period of life of the juvenile animals, comprising at least one visual stimulus, the at least one visual stimulus including a neck member being attachable to a component of the system such that the neck member can move with respect to the component, the neck member having an indicating portion for indicating a location of at least one feed/drink source, wherein, in operation, the indicating portion repeatedly alternates between a movement toward and a movement away from the location of the at least one feed/drink source.

In an embodiment, the neck member has first and second opposed ends, with the indicating portion being attached to the first end and with the neck member being attached to the component of the system.

In an embodiment, the neck member is pivotable relative to the component of the system.

In an embodiment, the indicating portion moves through an arc in a substantially vertical plane. The vertical plane is at normal to a ground surface.

In an embodiment, the indicating portion moves through an arc in a substantially horizontal plane. The horizontal plane is parallel to a ground surface.

According to a second aspect of the present invention, there is provided a method of increasing feed/drink attempts made by juvenile animals during an early period of life of the juvenile animals using the system of the first aspect, wherein the early period of life is a period in which the juvenile animals exhibit a neonate nutrient response.

According to a third aspect of the present invention, there is provided an apparatus for encouraging juvenile farm animals to move towards one or more selected locations, the apparatus comprising:

a visual system configured to generate a visual stimulus at or near each of the one or more selected locations;

an auditory system configured to generate an auditory stimulus at or near each of the one or more selected locations; and

a control system configured to operate the visual system to generate the visual stimulus at a first selected cycle frequency and configured to operate the auditory system to generate the auditory stimulus at a second selected cycle frequency.

An apparatus according to the third aspect may comprise first and second cycle frequencies of less than 500 cycles per minute. The second cycle frequency may be equal to the first cycle frequency. The control system may be configured to alternate between: operating the visual and auditory systems concurrently for an operating period; and halting operation of the visual and auditory systems for a non-operating period. Successive operating periods may vary in length of time. Successive non-operating periods may vary in length of time. In some embodiments, the operating periods may be less than 150 seconds in length. In some embodiments, the non-operating periods may be greater than 30 seconds in length.

In the apparatus according to the third aspect or the above embodiments, the auditory system may comprise one or more speakers configured to produce a sound which varies in intensity over each cycle. The sound intensity may be in the range of 35 dB to 85 dB. The visual system may comprise one or more lights which vary in brightness over each cycle. The one or more lights may blink on and off during each cycle.

In the apparatus according to the third aspect or the above embodiments, one or more devices may be disposed at or near one or more of the selected locations, each device forming part of the visual system and/or the auditory system. One or more of the devices may comprise a mechanism comprising an actuator and a first member connected to the actuator, the actuator being configured to be operated by the control system to move the first member relative to the actuator during each cycle. The mechanism may further comprise a second member, and the actuator may be configured to be operated by the control system to move the first member relative to the second member causing the first member to strike the second member at least once during each cycle.

In some embodiments, the second member may comprise a reverberation chamber to enhance the auditory stimulus. The first member may comprise an extended portion which is moved back and forth by the actuator to enhance the visual stimulus. One or more of the devices may further comprise a coupling portion for coupling the device to an item of farm equipment. The coupling portion may be configured to couple the device to one or more selected from: a food outlet, a feed line, a water outlet, a water pipe, and a structure supporting a food outlet, feed line, water outlet, or water pipe.

In some embodiments, when the device is coupled to an item of farm equipment, the actuator may be configured to be operated by the control system to move the first member such that the first member strikes part of the item of farm equipment at least once per cycle.

In some embodiments, a plurality of the devices may be connected to and controlled by the control system to encourage the juvenile farm animals to move towards a plurality of different selected locations, each selected location being associated with one of the devices.

In an apparatus according to the third aspect or the above embodiments, the auditory stimulus may comprise a water hammer effect produced by inducing successive pressure waves in a water pipe in successive cycles of the auditory stimulus. The intensity of vibrations caused by the auditory stimulus may be sufficient to cause at least part of the apparatus to visibly oscillate, thereby contributing to the visual stimulus.

According to a fourth aspect of the present invention, there is provided a method of using an apparatus according to the third aspect or the above embodiments to encourage juvenile farm animals to move towards one or more selected locations, by using the visual system to generate a visual stimulus at or near each of the one or more selected locations and using the auditory system to generate an auditory stimulus at or near each of the one or more selected locations.

According to a fifth aspect of the present invention, there is provided a method for encouraging juvenile farm animals to move towards one or more selected locations, the method comprising providing visual and auditory stimuli at or near each of the one or more selected locations, wherein the visual stimulus has a first selected cycle frequency and the auditory stimulus has a second selected cycle frequency.

In some embodiments, the first and second cycle frequencies may be less than 500 cycles per minute. The second cycle frequency may be equal to the first cycle frequency.

The method according to the fourth aspect or the fifth aspect or the above embodiments may further comprise alternately: generating the visual and auditory stimuli for an operating period; and halting generation of the visual and auditory stimuli for a non-operating period. Successive operating periods may vary in length of time. Successive non-operating periods may vary in length of time.

According to an embodiment, there is provided a method according to the fifth aspect or the above embodiments, wherein providing the auditory stimulus comprises operating one or more speakers to produce a sound at or near the location which varies in intensity over each cycle. Providing the visual stimulus may comprise operating one or more lights to vary in brightness over each cycle. Providing the visual and auditory stimuli may comprise operating an actuator to move a first member connected to the actuator at or near the location during each cycle.

In some embodiments, providing the visual and auditory stimuli may comprise operating the actuator to move the first member relative to a second member causing the first member to strike the second member at or near the location at least once during each cycle. Providing the visual and auditory stimuli may comprise operating the actuator to move the first member such that the first member strikes part of an item of farm equipment at or near the location at least once per cycle.

According to an embodiment, there is provided a method according to the fifth aspect or the above embodiments, wherein the auditory stimulus comprises a water hammer effect produced by inducing successive pressure waves in a water pipe at or near the location in successive cycles of the auditory stimulus. The visual stimulus may be provided as a result of providing the auditory stimulus, or the auditory stimulus may be provided as a result of providing the visual stimulus.

In some embodiments, the control system may be configured to alternate between: operating the visual and auditory systems concurrently for an operating period; and halting operation of the visual and auditory systems for a non-operating period. Successive operating periods vary in length of time, or in some embodiments, may be equal in length of time. Successive non-operating periods vary in length of time or in some embodiments, may be equal in length of time.

Preferably, the visual and auditory stimuli are provided concurrently or simultaneously. In some embodiments, the method may further comprise alternately generating the visual and auditory stimuli for an operating period; and halting generation of the visual and auditory stimuli for a non-operating period.

In some embodiments, the first and second cycle frequencies may be less than 500 cycles per minute, less than 350 cycles per minute, or less than 250 cycles per minute. In some embodiments, the first and second cycle frequencies may be between 100 and 110 per minute, 90 and 120 per minute, 60 and 180 per minute, 50 and 200 per minute, 10 and 100 per minute, 20 and 60 per minute, 30 and 50 per minute 190 and 260 cycles per minute, between 160 and 290 cycles per minute, or between 60 and 350 cycles per minute. The second cycle frequency may be equal to or different to the first cycle frequency.

For example, an indicating component moving alternately towards and away from the location of the food/drink source may do so preferably at a frequency of 190-260 cycles per minute, which the inventor has found to be particularly effective. Alternatively, the frequency could be 160-290 cycles per minute, or 60-350 cycles per minute. The motion could be a substantially vertical motion, which the inventor has found to be particularly effective, or substantially horizontal or at an angle.

In some embodiments, the operating periods may be less than 150 seconds in length, less than 120 seconds in length, less than 90 seconds in length, less than 60 seconds in length, or less than 30 seconds in length. In some embodiments, the operating periods may be between 20 and 260 seconds, 40 and 120 seconds, 50 and 75 seconds, 10 and 120 seconds, 20 and 75 seconds, 35 and 50 seconds, 10 and 260 seconds, 20 and 120 seconds, 30 and 60 seconds, 15 and 45 seconds in length, between 10 and 60 seconds in length, or between 5 and 120 seconds in length.

For example, the indicating component may cycle for between 15 and 45 seconds, which the inventor has found to be particularly effective. Alternatively, it may cycle for between 10 and 60 seconds or between 5 and 120 seconds. The inventor has found that, in general, the longer the operating period, the greater the number of juvenile animals attracted. Thus controlling this variable may allow control of crowding about a given food/drink source.

In some embodiments, the non-operating periods may be greater than 30 seconds in length, greater than 1 minute in length, greater than 5 minute in length, or greater than 10 minutes in length. In some embodiments, the non-operating periods may be between 15 and 120 minutes, 30 and 60 minutes, 40 and 45 minutes, 1 and 2 minutes, between 3 and 5 minutes, between 5 and 7 minutes, between 2 and 7 minutes, between 5 and 15 minutes, or between 1 and 30 minutes. In some embodiments, a longer non-operating period may be provided after a sequence of relatively shorter operating and non-operating periods. For example, the longer operating period may be greater than 15 minutes, greater than 30 minutes, greater than 1 hour, greater than 2 hours, greater than 4 hours, or greater than 8 hours.

In some embodiments, the alternating operating and non-operating periods may be selected to create a repeating pattern or sequence. In some embodiments, the alternating operating and non-operating periods may be varied to avoid creating excessively repetitive a pattern, and may be varied randomly in a randomly generated sequence.

For example, the movement pattern of an indicating component or other visual stimulus may be as follows: tapping/hitting/swinging/movement period-1 to 2 minutes rest-tapping/hitting/swinging/movement period-3 to 5 minutes rest-tapping/hitting/swinging/movement period-5 to 7 minutes rest-repeat. Rest periods may be between 0.5 seconds and 2 hours long.

In some embodiments, the auditory system may comprise one or more speakers configured to produce a sound which varies in intensity over each cycle. In some embodiments, providing the auditory stimulus may comprise operating one or more speakers to produce a sound at or near the location which varies in intensity over each cycle. The sound intensity at a distance of about 100 mm from the one or more speakers may be in the range of 35 dB to 85 dB, 80 dB to 85 dB, 82 dB to 83 dB, 40 dB to 70 dB, 45 dB to 60 dB, or 50 dB to 55 dB. At a distance of 10 cm to 15 cm, the sound intensity may be between 55 dB and 80 dB, though it could be between 40 dB and 90 dB or 35 dB and 120 dB.

In some embodiments, the visual stimulus may comprise one or more lights which vary in brightness over each cycle. In some embodiments, providing the visual stimulus may comprise operating one or more lights to vary in brightness over each cycle. For example, the one or more lights blink on and off during each cycle.

In some embodiments, the apparatus may further comprise one or more devices disposed at or near one or more of the selected locations, each device forming part of the visual system and/or the auditory system. One or more of the devices may comprise a mechanism comprising a first member connected to an actuator, the actuator being configured to be operated by the control system to move the first member relative to the actuator during each cycle. In some embodiments, the mechanism may further comprise a second member, wherein the actuator is configured to be operated by the control system to move the first member relative to the second member causing the first member to strike the second member at least once during each cycle.

In some embodiments, providing the visual and auditory stimuli may comprise operating an actuator to move a first member connected to the actuator at or near the location during each cycle. In some embodiments, providing the visual and auditory stimuli may further comprise operating the actuator to move the first member relative to a second member causing the first member to strike the second member at or near the location at least once during each cycle. In some embodiments, providing the visual and auditory stimuli comprises operating the actuator to move the first member such that the first member strikes part of an item of farm equipment at or near the location at least once per cycle.

The second member may comprise a reverberation chamber to enhance the auditory stimulus. The first member may comprise an extended portion which is moved back and forth by the actuator to enhance the visual stimulus. For example, a length of the extended portion may be in the range of 10 mm to 200 mm, 20 mm to 120 mm, 50 mm to 80 mm, 50 mm to 300 mm, 100 mm to 200 mm, or about 150 mm.

In some embodiments, the one or more of the devices may further comprise a coupling portion for coupling the device to an item of farm equipment, such as a food outlet, a feed line, a water outlet, a water pipe, a structure supporting a food outlet, feed line, water outlet, water pipe, or any other suitable structure.

In some embodiments, motion of each visual stimulus may be driven by a its own actuator or motor. In other embodiments, a single rod may be actuated to drive several of the visual stimuli.

When the device is coupled to an item of farm equipment, the actuator may be configured to be operated by the control system to move the first member such that the first member strikes part of the item of farm equipment at least once per cycle. This may provide one or both of the visual and auditory stimuli. In some embodiments, the apparatus may comprise a plurality of the devices connected to and controlled by the control system to encourage different ones of the juvenile farm animals to move towards a plurality of different selected locations, each selected location being associated with one of the devices.

In some embodiments, the auditory stimulus may comprise a water hammer effect produced by inducing successive pressure waves in a water pipe in successive cycles of the auditory stimulus. For example, the water pipe may be at or near the location and the vibration of the water pipe and/or structure supporting the water pipe may provide the auditory stimulus.

In some embodiments, the intensity of vibrations caused by the auditory stimulus may be sufficient to cause at least part of the apparatus to visibly oscillate, thereby providing or contributing to the visual stimulus. That is, the visual stimulus may be provided as a result of providing the auditory stimulus. In some embodiments, the auditory stimulus may be provided as a result of providing the visual stimulus.

Some embodiments relate to a method of using any one of the described apparatus to encourage juvenile farm animals to move towards one or more selected locations.

Some embodiments relate to a method of using an apparatus according to any one of the described embodiments to encourage juvenile farm animals to move towards one or more selected locations, by using the visual system to generate a visual stimulus at or near each of the one or more selected locations; and using the auditory system to generate an auditory stimulus at or near each of the one or more selected locations.

Some embodiments relate to a method for encouraging juvenile farm animals to move towards one or more selected locations, the method comprising providing visual and auditory stimuli at or near each of the one or more selected locations, wherein the visual stimulus has a first selected cycle frequency and the auditory stimulus has a second selected cycle frequency.

Embodiments relate generally to systems, methods and apparatus for attracting juvenile farm animals, or encouraging juvenile farm animals to move towards one or more selected locations. Some embodiments relate to a method of raising juvenile farm animals to enhance welfare of juvenile farm animals in the absence of natural maternal care.

As used herein, the term “about”, unless stated to the contrary, refers to +/−10%, more preferably +/−5%, more preferably +/−1%, of the designated value.

As used herein, the term “and/or” means “and”, or “or”, or, where circumstances permit, both.

### Farm Animal

The term “farm animal” as used in the context of the present disclosure to refer to precocial animals. The farm animal may be selected from poultry (such as chickens, ducks, turkeys, and geese), cattle, goats, sheep, and pigs. The farm animal may be poultry. The farm animal may be chickens.

The term “juvenile” as used in the context of the present disclosure to refer to the age of the farm animal. The age of the farm animal may be at any age from birth to weaning age. For example, a juvenile chicken may refer to a chicken that has just hatched, is one day old, is one week old, is three weeks old, or is five weeks old. Preferably, the juvenile animal, particularly in the case of chickens, ducks or other avian species, is aged within the first week post-hatch or post birth. More preferably, the juvenile animal is aged within the first twenty-four hours.

The typical weaning age for chickens may be from about 3 to about 15 weeks.

The typical weaning age for calves may be from about 4 to about 12 months. The typical weaning age for lambs and/or goats may be from about 8 to about 24 weeks. The typical weaning age for piglets may be from about 1 to about 8 weeks.

For example the weaning age may be from about 0 to about 365 days, about 0 to about 185 days, about 0 to about 175 days, about 0 to about 165 days, about 0 to about 155 days, about 0 to about 145 days, about 0 to about 135 days, about 0 to about 125 days, about 0 to about 115 days, about 0 to about 105 days, about 0 to about 95 days, about 0 to about 85 days, about 0 to about 75 days, about 0 to about 65 days, about 0 to about 55 days, about 0 to about 50 days, about 0 to about 45 days, about 0 to about 40 days, about 0 to about 35 days, about 0 to about 30 days, about 0 to about 25 days.

In respect of behavior of juvenile animals (for example chicks) that can be influenced, the following terms are defined and explained:

### Activation of Juvenile Animals:

A behavior of juvenile animals characterised by a change from a lower energy state to a higher energy state (e.g. from sleep to wakefulness, from a resting position to a standing position, from standing to movement) in response to a stimulus.

### Engagement of Juvenile Animals:

A behavior of juvenile animals whereby they initiate feeding and/or drinking, or make a feeding/drinking attempt.

### Primary Activation & Secondary Activation:

In a group of juvenile animals (for example chicks) that are presented with a stimulus, activation may fall under one of two categories: primary activation or secondary activation. Primary activation is defined by activation of juvenile animals that occurs directly in response to the stimulus.

Secondary activation is defined by activation of juvenile animals that occurs indirectly in response to the stimulus. In particular, juvenile animals exhibit secondary activation under influence of their primary-activated peers or of their secondary-activated peers.

Primary Activation is Optimised by I) Making the Stimulus Attractive and/or II) Taking into Account Animal Bias:

i) Attractiveness of stimulus: Juvenile animals will find some specific stimuli inherently more interesting than others. The system can be designed to maximise inherent attractiveness of the stimulus to the juvenile animals.

ii) Animal bias: There are features of the species of juvenile animal that will make them more or less likely to activate/engage with a stimulus. Some of the main biases include:
a. neonate nutrient response—the innate tendency for young animals, within the first moments of life, to respond to a specific set of stimuli by hunting for nutrients and making a feeding/drinking attempt. This bias is an instinctive, non-learnt response. In chickens, mother hens use specific movements such as gesturing with a head motion or leg motion towards food and water. Chicks, during the first several days of life are instinctively drawn to that movement but also instinctively compelled to perform feeding/drinking behavior at the substance to which the mother hen is gesturing;
b. habituation—the diminishing of a response to a stimulus that previously elicited a response;
c. conditioning—where a response to a stimulus is positively reinforced through association with food and/or water.

### Secondary Activation Influences:

Secondary activation is influenced by the same forces that affect primary activation but is maximized when there is a maximum number of primary-activated individual juvenile animals, and where the movement differential between pre-stimulus and post-stimulus is maximized. For example, a greater secondary activation effect is seen when primary-activated chicks move from rest to brisk movement, rather than from slow movement to fast movement.

### Group Size and Mass Movement Effect:

Larger groups of young animals will move and respond to stimuli in different movement and activation patterns compared to smaller or more natural group sizes. In chickens, a natural brood size may be 5 to 25 chicks, whereas commercial chicken farms may have 1000 to 100 000 chicks.

### Small Group Activation/Engagement Characteristics:

In smaller groups, the present inventor has found that it is common that either a majority of the group will activate/engage, or none or very few will. By contrast, in a large group, it is more common to see only a portion of the group engaging for a given instance of auditory and visual stimulus, such as during each operating period of the system.

### Large Group Activation/Engagement Characteristics:

Large groups demonstrate a Mass Movement Effect, whereby a small number of primary-activated young animals move towards the stimuli and propagate a wave of secondary-activated animals. A first group of secondary-activated animals may move towards the stimuli which will in turn activate a second group of secondary-activated animals, which will activate a third group, etc. This propagates throughout the group resulting in the majority of young animals in the area being activated.

While the above concepts have been primarily elaborated in relation to chicks, it will be understood that similar or analogous behaviours and characteristics exist for other juvenile farm animals.

### Auditory/Visual Stimuli

Farm animals may use visual and auditory stimuli, such as movement, vocalisation or tapping, to communicate with others in the social group. This may be to signal danger, distress, contentment, the availability of food, intention to fight and a variety of other purposes.

Where an auditory stimulus is provided, juvenile farm animals may be attracted to the auditory stimulus: they may look up at it and may be encouraged to move towards it, i.e., the juvenile farm animals thus become activated.

Where visual stimuli are provided, such as the movement of a maternal figure, juvenile farm animals may respond to the visual stimuli, by moving towards the visual stimuli or mimicking the behaviour of the maternal figure.

Maternal figures may use visual and auditory signals to communicate to their offspring for a similarly diverse range of purposes. For example in poultry production such signals may be used to synchronise activity of chicks within the shed, or to encourage chicks to eat or sleep at a particular time.

In juvenile animals, it has been found that directive stimuli is very important in teaching a juvenile animal what it should be engaging with. A directive stimulus uses motion to “point” to a specific location such that the attention of the juvenile animal is focused on that location and not simply a general region. In particular, juvenile farm animals have been found by the inventor to respond to natural motion characteristics of a maternal figure which elicit the neonate nutrient response. The inventor has found that natural motion replication can be achieved by causing a device to move through key articulation points that correspond to articulation points in a natural maternal figure.

Other, non-directive stimuli may include flashing lights, speakers, which provide some level of activation and sometimes even engagement in juvenile animals but significantly less than the directive stimuli. However, in overall systems for large group sizes of juvenile animals, it has been found to be beneficial to use directive stimuli as principal stimuli in conjunction with non-directive stimuli as ancillary stimuli (as discussed later in more detail).

It is thought that concurrently providing visual and auditory stimuli at particular cycle frequencies is effective in activating and engaging certain juvenile farm animals, such as chicks, for example. Advantageously, providing auditory stimuli in addition to visual stimuli can help to activate/engage juvenile animals by avoiding a situation where the juvenile animal initially does not receive a visual signal because it is looking in a different direction. In particular, it is thought that providing at a feed/water outlet an auditory stimulus which either mimics or has a similar cycle frequency to the natural clucking or pecking of mother hens, and associated visual stimulus/stimuli, can attract chicks, encourage them to move towards the auditory and visual stimuli, and consume the food/water.

The neonate nutrient response (NNR) is displayed within the first phase of life of juvenile animals (0 to 4 days for most chicks, though some chicks may show the response up to 7 days) and wanes over time. During the NNR phase, the animals' ability to recognize feed is low and thus they rely on external stimuli and exploratory behaviours, not only to find food and water, but to learn what food and water is. After a period of time, the juvenile animals will associate feed materials with the sensation of feeding and being full. Similarly, they will associate water with quenching thirst. There are thus two mechanisms of action promoting juvenile animals to activate and engage: a primary mechanism (the NNR response) and a secondary mechanism of conditioning whereby the juvenile animal comes to associate the stimuli with food/water by positive reinforcement. This secondary mechanism is strongest during the period after the primary mechanism NNR response wanes (i.e., between 5 to 14 days post-hatch in the case of chicks).

It is preferable to take appropriate advantage of the NNR phase and post-NNR phase respectively. In particular, juvenile farm animals should preferably be exposed as early as possible during the NNR phase to a system for activation and engagement. Additionally, the stimuli should be paired with food/water exclusively. This reduces the risk that secondary mechanism (conditioning) is compromised due to the juvenile animal not receiving consistent reward for responding to the stimuli. Advantageously, introducing the systems disclosed herein during the NNR phase can reduce mortalities and additionally improve feed use efficiencies.

In some embodiments, the visual stimulus may be distinct from the auditory stimulus. In some embodiments, the visual stimulus may be a direct result of the auditory stimulus, such as a visible oscillation or vibration caused by the auditory stimulus.

In some embodiments, the visual stimulus may be configured to give an impression of movement. For example, a moving mechanism or a moving or blinking light. In some embodiments, a plurality of lights may be controlled to light up in sequence to give the impression of movement. In some embodiments, a laser may be directed to illuminate a first area near a selected location and gradually redirected to illuminate a second area which is nearer to the location than the first area. The laser may be further redirected to illuminate the selected location itself. This process may be repeated to encourage the juvenile animals to move towards the selected location and to feed or drink.

In some embodiments, the lights 810 may have a selected colour, such as natural white light, warm coloured white, cool coloured white, ultra violet, blue, green, yellow, orange, red, or infrared, for example.

### Auditory Stimulus Characteristics

The auditory stimulus may comprise a sound generated by a mechanical device, such as tapping or clicking, or a recorded audio signal broadcast by one or more speakers. For example, the audio signal may include a recording of tapping, clicking, music, or natural or artificial animal sounds, such as clucking, pecking, quacking, chirping, cooing, mooing, bleating, oinking, snorting, other vocalisations or tapping.

Preferably the volume of the auditory stimulus should be greater than the ambient noise around the juvenile animals and will be species-specific. If the auditory stimulus is too soft, the juvenile animals will not hear it and it will not be effective. In contrast, if the stimulus is too loud, it will startle the juvenile animals. In a particularly preferred embodiment for juvenile chickens, the volume of the auditory stimulus 10 cm from the source of the auditory signal or 20 cm from the feed/water outlet is between 82-90 decibels. During periods of higher stress, for example during placement of chicks in a new area, the chicks may generate a noise in excess of 90 decibels. In this case, the volume of the auditory stimulus should not be above 90 decibels as it may startle the chicks. It is expected that chicks will quieten to below 82 dB once settled.

The auditory stimulus pitch should vary, as well as the number of discrete tones, though there should also be an identifiable and repeating pattern. If a single tone at a single pitch is provided, the juvenile animals are less likely to engage and habituation sets in. Preferably, the auditory stimulus will comprise three to ten discrete tones of varying pitch. Fewer than three tones may result in habituation while greater than ten tones may result in a pattern length that is too long for the juvenile animals to readily identify. The presence of a pattern helps with distinctiveness of the auditory stimulus (so that the juvenile animals can distinguish the auditory stimulus from the complex farm soundscape). In preferred embodiments, the pattern consists of between three and six tones. In a particularly preferred embodiment, the pattern consists of four tones. Preferably, the sequence of notes for chicks is C-C-D-E. For example, the sequence may be C4-C4-D4-E4.

### Visual Stimulus Characteristics

The visual stimulus may comprise a device exhibiting movement. In particular, the device may exhibit movement corresponding to the motion characteristics of a natural maternal figure. In the case of chickens, the device may have three major components that generally correspond to the beak, neck and articulation point (where the neck connects with the body) of a hen. Advantageously, where the component corresponding to the beak (i.e. an indicating portion) is readily distinguishable from the component corresponding to the neck (e.g. neck member), this allows a clearer indication of what substance is being pointed to. For example, the indicating portion is generally provided at right angles to the neck member. The indicating portion has a length that extends or protrudes from the neck member. Preferably, the length of the indicating portion is between 20 mm and 50 mm.

Preferably, there are no “pinch points” created between the beak component and any other part of the system or farm equipment to avoid chicks becoming stuck by the device. If a chick were to be caught by a pinch point, this may cause distress or harm, and may cause the chick to associate the stimulus with a negative experience, thus reducing the effectiveness of the system overall. Preferably, the device is constructed so as to be adjustable if a pinch point arises (e.g. by rotating or bending the neck component to provide additional space and eliminate the pinch point).

Preferably, the component corresponding to the neck is a member having a length between 100 mm and 200 mm and provides the main visual aspect of the movement by swinging through an arc. If the swing is too long, this may result in a speed of motion that is too slow to be effective. Conversely, if the swing is too small, the movement may not be apparent to the chicks. In a preferred embodiment, the neck component swings through an arc of between 60° and 90°. In preferred embodiments, the articulation point is located at the upper end of the neck component with the indicating portion extending below.

In some embodiments, the device may strike another part of farm equipment or a resonance chamber to produce an auditory stimulus. In some embodiments, the device may be arranged or configured in such a way that no pinch points are created where the juvenile animal could become trapped or injured. For example, the neck may be rotated/bent as described above. As a further example, the device may be made from a resiliently deformable material.

In some embodiments, the device may be coloured to enhance activation and engagement. The colour should be selected based on the species. In the case of ground fowl, red has been found to be the most effective. Red is also typically effective across different livestock species. Consideration should be given to contrast with the environment around the food/water source. For example, if red is not appropriate, and the feeder and food is yellow, it would be preferable to select blue. Optionally, the device could be multi-coloured.

A flag or other enhancer may also be provided on the device in certain embodiments. While the directive motions of the device should be as close as possible to the food/water source, the food/water is often provided at a height at which animals can easily reach (i.e. about the head height of the juvenile animals). Therefore, it may be difficult for juvenile animals further away to see the stimulus over the heads of their fellow animals (particularly in groups of greater than 1000 animals). In such instances, it is advantageous to include an enhancer on the moving device. The enhancer itself moves in concert with the device, though preferably at least 5 cm above the food/water source (in the case of chicks). More preferably, the enhancer may be 10 cm above the food/water source. Preferably the enhancer should not be higher than 30 cm above the food/water source to avoid intimidating the chicks.

Preferably the visual stimulus device and all other components of the system should be water resistant and be easy to clean to limit potential for spreading disease. For example, the surfaces may preferably be smooth and simple in shape to limit their ability to trap fluids and germs. Examples of material(s) used to construct the device and other components of the system include plastic, silicon, aluminium, iron, steel and sealed wood. It is also possible to use untreated wood.

### Placement of Stimuli

Importantly, all stimuli should be placed in close proximity to the food/water locations. Attempts have been made in the prior art to activate/engage young animals by using music in close proximity to the animals, though with limited success. It has been found that if the stimuli are not within 30 cm of a food/water source or well above the height of the juvenile animals, such systems typically fail to sufficiently engage the juvenile animals, even if they manage to activate the animals. Accordingly, there has been little uptake of such systems in commercial settings. A possible undesirable outcome of using stimuli too far from the food/water source is that the juvenile animals may make feeding/drinking attempts at a non-nutrient source. Additionally, the opportunity for association between the stimuli and the food/water source may be lost as the NNR effect fades.

Preferably, in the case of chicks, the stimuli should be no greater than 30 mm from the food/water source. However, it may also be preferable that a directive visual stimulus is no less than 15 mm from the food/water source, to avoid the risk of chicks becoming trapped in a pinch point created between the device and the source, and being potentially injured or traumatised. Preferably, the directive visual stimulus device is also resiliently deformable to minimise harm to a chick in the event that they do become caught in a pinch point or are struck by the device.

In some embodiments, the visual and auditory stimuli may be provided at a plurality of different selected food/water locations so that different ones of the juvenile farm animals are encouraged to move towards different selected locations. In some embodiments, the visual and auditory stimuli may be provided at different locations at different times in order to encourage the juvenile farm animals to move to the different locations at the different times. For example, this may encourage the juvenile farm animals to move further than they might otherwise, or in some embodiments, this method may be used to encourage the juvenile farm animals to eat, drink, bond and sleep at different times.

Preferably, the spacing of the stimuli is optimized to maximize engagement of the juvenile farm animals at desired times. In particular, it is preferable not to have stimuli at every food/water outlet, but rather to have stimuli placed at regularly spaced intervals. If the spacing is too close, there is a risk that the animals will be drawn in multiple directions, or not move at all due to confusion. Additionally, the effect of secondary activation (on the animals that are not immediately proximate to the outlets) may be diluted because the primary-activated animals are not moving in a single direction. If the spacing is too far apart, there will be insufficient target points for the young animals, which will in turn: a) respond insufficiently; or b) gather in greater numbers around their closest food/water outlet resulting in many of the animals being unable to access it.

Preferably, in the case of chicks, principal stimuli should be spaced such that there is one principal stimulus system every 1 to 4 meters, and not on every food/water outlet. Typically the principal stimulus system will comprise a visual stimulus having directive characteristics (e.g. natural movement replication). In the case of a drinking line, it may be preferable to have one principal stimulus system every 1 to 3 meters, or more preferably at intervals of 1.6 meters. In the case of a feeding line, it may be preferable to have one principal stimulus system every 1 to 4 meters, or more preferably at intervals of 3.5 meters. It will be appreciated that optimal spacing will depend on the size and shape of the food/water outlet and the number of juvenile animals that can access the outlet simultaneously.

In some embodiments, where there is not a principal stimulus on every food/water source, more juvenile animals may be attracted to the source than can access the source at any given time. In such cases, ancillary stimuli (e.g. as non-directive activators such as lights) are placed nearby the principal stimuli in order to distribute the excess animals towards adjacent food/water outlets. These animals may be less successful in engagement than their peers that reach the food/water source initially. However, the inventor has found that it is still more effective to operate the system in this way than to have insufficient space between the principal stimuli, or indeed than to have no ancillary stimuli in place.

One disadvantage of not having a principal stimulus system on every food/water source is that more animals will be attracted to the source than can access the source at any given time. This means that the juvenile animals will have been activated by the system and are engaging (by making an attempt to feed/drink) but are not having the opportunity to actually feed/drink. In such cases, it is desirable to distribute the excess animals towards adjacent food/water outlets, which can be achieved by placing ancillary stimuli (such as non-directive activators such as lights) nearby. These animals may be less successful in engagement. However, it has been found that it is still more effective to operate the system in this way than to have insufficient space between the primary activators, or indeed than to have no ancillary stimuli in place.

### Cycle Frequencies

Selection of cycle frequency should be species-specific. If the cycle frequency is too slow, the system may have a lower, or possibly no activation and/or engagement effect. If the cycle is too fast, it can scare juvenile animals and discourage them from moving towards the stimuli. When selecting a cycle frequency for the flock, it is preferable to start with an initial desired frequency prescribed for the species (for example, 180 beats per minute for chicks) and to adjust according to the temperament of the particular group of animals and the desired level of activation.

A person skilled with interpreting bird behavior will be able to walk through an enclosure and assess the character and temperament of the flock by observing how many birds move away. Some key factors include the radius of space created as the birds move away in combination with such factors as age and environment. In general, birds may be initially more docile in early stages of life in the enclosure and are also more docile in low light. Starting from the initial prescribed frequency (e.g. 180 bpm for chicks) and taking into account the assessment of the group character, the user may adjust the frequency to be faster or slower by about 5 bpm, as appropriate. The adjustment may be performed in increments of 5 bpm, and the behavior of the chicks observed for a period of time, before a further adjustment is made. For chicks, the variation would generally be in the range of about 160 bpm to 240 bpm.

Generally, provided that the cycle frequency falls within a predetermined species-specific range that the juvenile animals will respond to, a faster speed will have a greater engagement/activation response and vice versa. A group of animals that is particularly more flighty than average will generally respond better to lower cycle frequencies, whereas a more docile group will generally respond better to higher frequencies. However, if the cycle frequency falls outside of the species-specific range (e.g. too fast or too slow), no effect may be observed at all.

In certain instances, there may be specific periods where increased nutrient uptake is desirable (for example, increased water uptake on hot days or increased food uptake on cold days). In these cases, the group of animals may show a disinclination to move and the cycle frequency can be increased further during this time to encourage activation and engagement.

It may also be advantageous to increase the cycle frequency during periods are known to be naturally high activity periods and to direct the activity towards food/water. For example, chickens are known to be more active at dusk and dawn. Thus the system can be set up to operate at a higher cycle frequency to take advantage of those periods. Again, the system could begin from an initial prescribed frequency and be adjusted, for example increased, by 5 bpm increments.

### Operation Periods

In some embodiments, the method may further comprise alternately operating the visual and auditory stimuli for an operating period; and halting operation of the visual and auditory stimuli for a non-operating period. Preferably, where multiple stimuli are placed throughout an enclosure, all stimuli should be operational simultaneously and non-operational simultaneously. This is to avoid a situation where certain juvenile animals move towards a particular operational stimulus location that they otherwise would not and having access to the food/water source blocked by their peers.

Advantageously, having all stimuli operational simultaneously also promotes synchronicity amongst the flock. The inventor has observed that if groups of animals are eating and/or drinking at the same times, they tend to be more synchronous in their activity, i.e. they eat, drink and sleep at the same time. A further observation is that when animals are more synchronous in sleep, they disturb one another less during and sleep, thus improving the quality of sleep. This in turn promotes healthy growth in the animals.

In some embodiments, the alternating operating and non-operating periods may be selected to create a repeating pattern or sequence. In some embodiments, the alternating operating and non-operating periods may be varied to avoid creating too repetitive a pattern, and may be varied randomly in a randomly generated sequence. It may be desirable to randomly vary the lengths of operating and non-operating periods within a set range, to avoid habituation of the juvenile farm animals.

For example, the inventor has found that if the operating periods and non-operating periods vary in length to one another and/or each respective length of period varies, the juvenile animals do not habituate and will continue to respond to the stimuli over time.

In fact, there are benefits to both long intervals and short intervals of rest time. By varying the lengths of the operating and non-operating periods it is possible to benefit from both sets of advantages.

Longer rest times can encourage secondary activation. If a majority of juvenile animals are at rest directly before an operating period begins, the movement differential of primary-activated juvenile animals is maximised. This in turn increases the number of secondary activated young animals. Preferably, a long rest period in chicks is between 15 to 20 minutes, which allows much of the flock to settle and be at rest. Rest periods of longer than 45 minutes may be less desirable as the chicks may not be feeding/drinking enough.

Short rest times may maximise group engagement. After an operating period, there may be juvenile animals that have been activated and are attempting to feed/drink but are unable to access the food/water source. If a short rest period follows such an event, the animals that have attempted to feed/drink are again directed at the food/water source at a time when the other animals have only just eaten/drunk and are less likely to activate again so soon. A particularly preferred short rest duration that has been found for chicks is between 7 and 10 minutes. While rest periods of less than 5 minutes may be used in short bursts, particularly in the first hour post placement of the chicks in the enclosure, habituation will likely occur, resulting in lower levels of responses from the juvenile animals.

As mentioned above, there are typical species-specific ranges of cycle frequencies within which changes to the frequency will elicit changes varying degrees of activation and engagement in a group of juvenile animals. Similarly, increasing the length of the operating period within the prescribed operating period for a given species may result in increased engagement. Conversely, decreasing the length of the operating period within the prescribed operating period for a given species may result in decreased engagement.

A preferred length of operating period for chicks has been found to be between 1 and 3 minutes and should be modified based on the temperament of the flock and the desired level of activation and engagement, using similar techniques as described above under “Cycle frequencies”. If the operation period is longer than 3 minutes, the chicks tend to habituate and the level of response reduces. If the operation period is less than about 1 minute, there may be insufficient time for secondary activation to occur and only the most responsive and large birds will have the opportunity to move towards the stimuli in time.

### Turning the System Off

Although it is possible to run the system constantly through its operation and non-operation periods, this may be less desirable as it does not allow a rest time for the animals. Preferably, there would be an extended block of time each day during which the system is completely turned off. Preferably, such a period may coincide with periods of darkness (i.e. when the lights are turned off) or at night. The system preferably should remain on at all other times (though still having operation and non-operation periods). Extended periods of the system being turned off outside of rest periods may result in less activation and the system may be less effective.

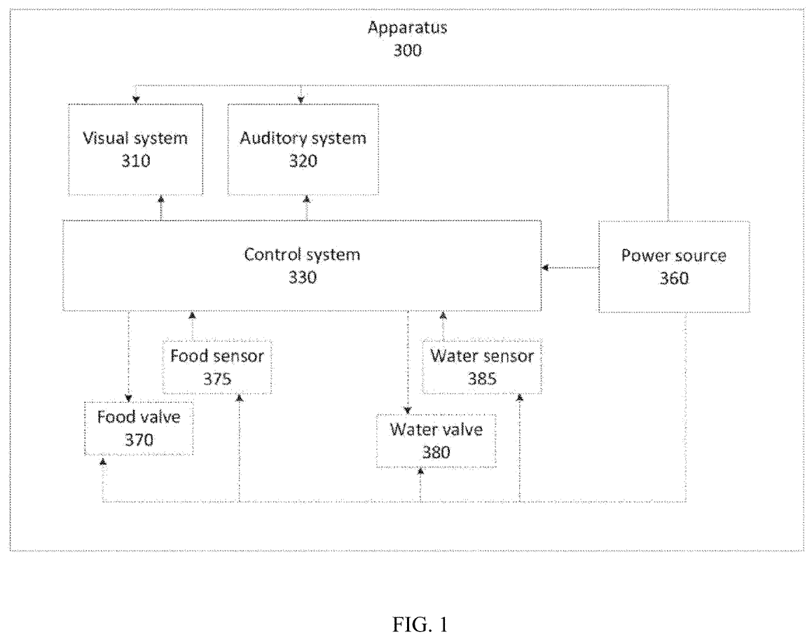

Referring to FIG. 1, an apparatus 300 for encouraging juvenile farm animals to feed or drink from one or more selected locations is shown in a schematic diagram, according to some embodiments. The apparatus 300 comprises visual system 310 configured to generate a visual stimulus, an auditory system 320 configured to generate an auditory stimulus, and a control system 330 configured to operate the visual and auditory systems 310, 320.

The control system 330 may be configured to operate the visual system 310 to generate the visual stimulus at a first selected cycle frequency and configured to operate the auditory system 320 to generate the auditory stimulus at a second selected cycle frequency.

In some embodiments, the visual system 310 and auditory system 320 comprise separate components or systems of the apparatus 300. In some embodiments, the auditory system 320 may also provide part of the visual system 310. In some embodiments, the auditory system 320 may also comprise the entirety of the visual system 310. In some embodiments, a single component or system of the apparatus 300 may provide both the auditory system 320 and the visual system 310.

The apparatus 300 may be installed in a farm to encourage juvenile farm animals to feed or drink from one or more selected locations on the farm. For example, the one or more selected locations may include items of farm equipment, such as food outlets, feeding areas, water outlets, drinking areas, shelters, paddocks, pens, cages, or processing areas.

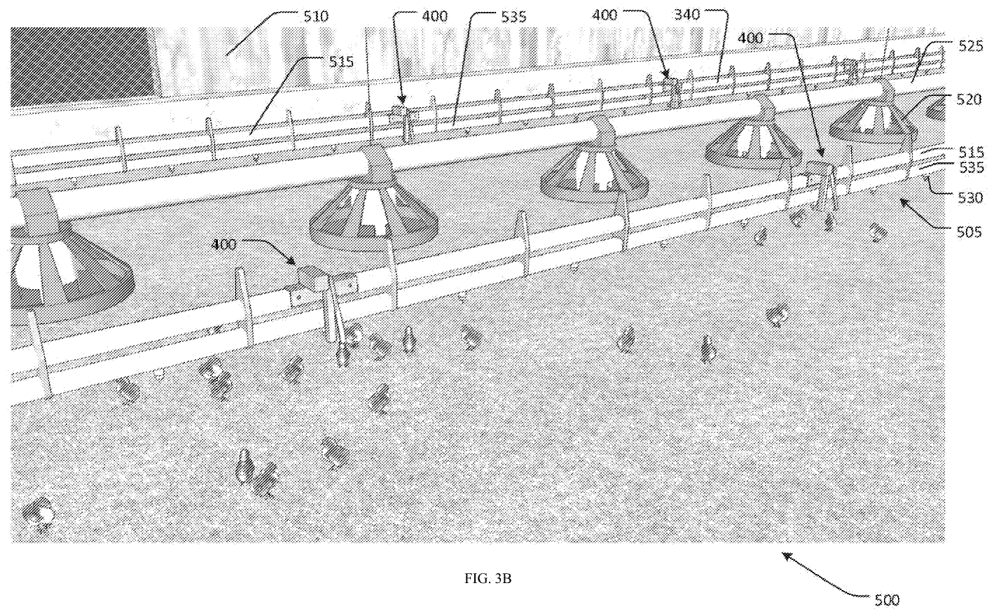

Referring to FIG. 3B, part of a chicken farm 500 is shown, according to some embodiments. The farm 500 includes farm equipment 505 accommodated in a shelter or warehouse 510. The farm equipment 505 may include one or more food containers or food outlets 520 or water containers or water outlets 530.

In some embodiments, the farm equipment 505 may include feed lines or pipes 525 for delivering food to a plurality of food outlets 520. The farm equipment 505 may also include water lines or pipes 535 for delivering water to a plurality of water outlets 530.

In some embodiments, the farm equipment 505 may include supporting structures 515 to support one or more of the food outlets 520, feed lines 525, water outlets 530 and water pipes 535.

For example, referring to FIGS. 3A and 3B, a support structure 515 is shown in the form of a rigid pipe to support the water pipe 535 suspended below the support structure 515 via brackets.

Referring back to FIG. 1, the visual and auditory systems 310, 320 may be configured to provide the visual and auditory stimuli at or near the food outlets 520, feed lines 525, water outlets 530, or water lines 535, to encourage the juvenile farm animals to move towards and potentially interact with those items of farm equipment 505 at selected locations at certain times.

In some embodiments, the apparatus 300 may comprise one or more food valves 370 and/or water valves 380 to control the flow of food and/or water to the food outlets 520 or water outlets 530, respectively. For example, the food valves 370 may be disposed at one or more locations along the feed lines 525 or at each of the food outlets 520. The water valves 380 may be disposed at one or more locations along the water lines 535 or at each water outlet 530.

The food and water valves 370, 380 may be operated (opened and closed) by the control system 330 to control the availability of food and water and encourage the juvenile farm animals to eat or drink at certain times. The visual and auditory stimuli may be generated at or near the food or water outlets 520, 530 when the food or water is available to encourage the juvenile farm animals to eat or drink at those times.

In some embodiments, the apparatus 300 may comprise one or more food sensors 375 or water sensors 385 configured to monitor the intake of food and water by the juvenile farm animals. For example, the sensors 375, 385 may be configured to detect a flow rate of food or water in the food or water lines 525, 535, or detect a weight of the food held in food containers at the food outlets 520, and provide a signal to the control system 330 to monitor the intake of food or water by the juvenile farm animals. The sensors 375, 385 may be configured to monitor the food or water intake over a particular feedline 525 or water line 535, or may be configured to monitor food or water intake from individual food outlets 520 or water outlets 530.

If food or water intake is lower than desired, the control system 330 may be configured to respond by increasing the length and/or frequency of feeding times (or operating periods), or the cycle frequency or intensity of the auditory or visual stimuli, to encourage the juvenile farm animals to eat and/or drink more.

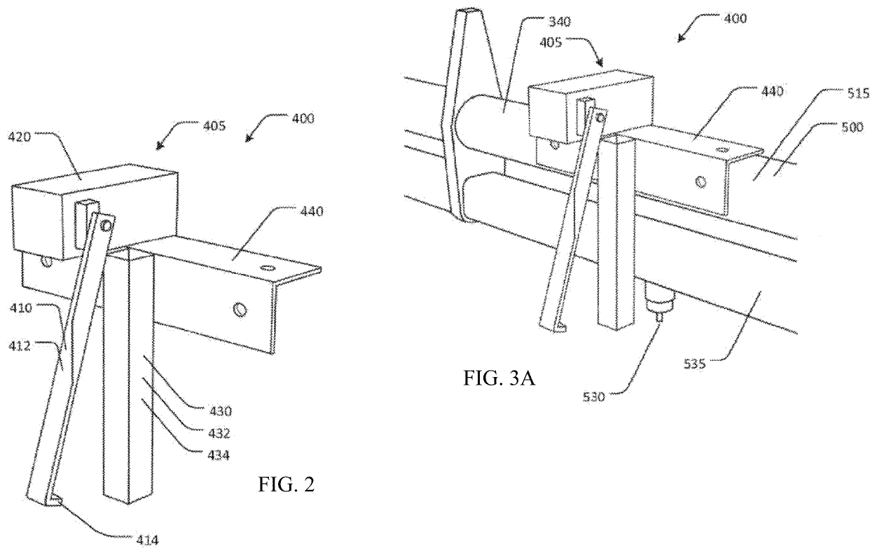

In some embodiments, the apparatus 300 may comprise one or more discrete devices 400 (shown in FIG. 2) which may form part of the visual and/or auditory systems 310, 320. Each of the devices 400 may be positioned at or near one of the selected locations, such as near an item of farm equipment 505. In some embodiments, one or more of the devices 400 may be coupled directly to an item of farm equipment 505 (as shown in FIG. 3B).

The apparatus 300 may further comprise a power source 360 coupled to one or more of the visual system 310, auditory system 320, control system 330, food valve 370, food sensor 375, water valve 380, and water sensor 385, to supply power to those components. In some embodiments, the control system 330 may control the visual system 310, auditory system 320 by controlling the power supplied to those components by the power source 360.

In some embodiments, the apparatus 300 may comprise a service line conduit 340 with cables connecting one or more of the visual system 310, auditory system 320, control system 330, food valve 370, food sensor 375, water valve 380, water sensor 385, and device 400 to the control system 330 and/or to the power supply 360. For example, referring to FIGS. 3A and 3B, in some embodiments, the service line conduit 340 may be provided in the form of a rigid pipe, and may serve the dual purpose of providing a service line conduit 340 as well as forming part of a supporting structure 515.

The service line conduit 340 may include one or more electrical cables for distributing power and or communication signals, such as control signals or sensor signals, around the apparatus 300 between the various components of the apparatus 300. In some embodiments, there may be dedicated signal cables for communication with each of the visual system 310, auditory system 320, control system 330, food valve 370, food sensor 375, water valve 380, water sensor 385, and device 400.

The control system 330 may be configured to alternate between operating the visual and auditory systems 310, 320 concurrently for an operating period, and halting operation of the visual and auditory systems 310, 320 for a non-operating period. Successive operating periods may vary in length of time, or in some embodiments, may be equal in length of time. Successive non-operating periods may vary in length of time or in some embodiments, may be equal in length of time.

In some embodiments, the control system 330 may comprise an electronic controller or computer. In some embodiments, the control system 330 may comprise a mechanical control system. For example, a system of gears, cogs, cams, and/or mechanisms, configured to control the cycle frequencies and/or timing of the operating and non-operating periods.

Referring to FIG. 2, a device 400 is shown, according to some embodiments. The device 400 comprises a mechanism 405, which contributes to generating the auditory stimulus and the visual stimulus. The device 400 or mechanism 405 may comprise a tapper or tapping mechanism, for example.

The mechanism 405 may comprise a first member or striker 410 connected to a motor 420. In other embodiments, the striker may be connected to an actuator. The motor 420 may be configured to be operated by the control system 330 to move the striker 410 relative to the motor 420 during each cycle. The striker 410 may comprise an elongate arm 412 coupled to the motor 420 at or near a first end of the arm 412 and a striking head 414 at or near a second end of the arm 412.

The arm 412 may have a length in the range of 10 mm to 200 mm, 20 mm to 120 mm, 50 mm to 80 mm, 10 mm to 300 mm, 20 mm to 200 mm, 50 mm to 150 mm, or about 100 mm.

The mechanism 405 is arranged for natural motion replication of a mother hen, comprising a beak component (striking head 414), a neck component (first member of striker 410) and articulation point (where the first member of the striker 410 is coupled to the actuator or motor 420).

In some embodiments, the actuator or motor 420 may be mechanically coupled to and configured to move a plurality of strikers 410 to contribute to the visual and/or auditory stimuli.

The device 400 or mechanism 405 may further comprise a second member 430, and the motor 420 may be configured to be operated by the control system 330 to move the striker 410 relative to the second member 430 causing the striker 410 to strike the second member 430 at least once during each cycle.

In some embodiments, the second member 430 may comprise a reverberation chamber 432 to enhance the auditory stimulus. For example, the reverberation chamber 432 may comprise a hollow member, such as a tubular member, surrounding a volume of air which reverberates when a sidewall 434 of the reverberation chamber 432 is struck. In some embodiments, the reverberation chamber 432 may comprise one or more membranes covering openings in the hollow member to enhance the reverberation effect. In some embodiments, the second member 430 may comprise a solid form.

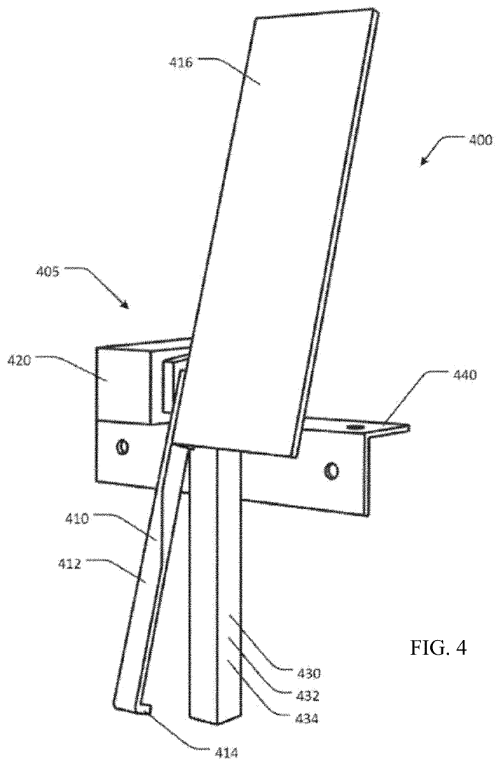

Referring to FIG. 4, in some embodiments, the first member or striker 410 may comprise an extended portion or extension 416 (i.e. the flag or enhancer described previously) to enhance the visual stimulus by making the movement of the arm 412 more visible. For example, the extension 416 may extend a length or a width of the arm 412. In some embodiments, the extension 416 may extend from the first end of the arm 416, as shown in FIG. 4, for example. The extension 416 moves in concert with the arm 412.

In some embodiments, the extension 416 may be brightly coloured to increase the visibility of the extension 416. For example, the extension 416 may be coloured red, orange, yellow, pink, green or blue. The extension may also be multi-coloured. In other embodiments, the extension 416 may have a metallic colour, such as grey or silvery steel, for example.

In some embodiments, the striker head 414 may be decorated to simulate or give the impression of a bird's head, such as a chicken head, duck head, or goose head, for example, to further enhance the visual stimulus.

In some embodiments, the device 400 may further comprise a coupling portion 440 for coupling the device to an item of farm equipment 505, such as a food outlet 520, a feed line 525, a water outlet 530, a water pipe 535, a structure supporting a food outlet, feed line, water outlet, water pipe, or any other suitable structure. For example, referring to FIGS. 3A and 3B, the mechanism 400 is shown connected via the coupling portion 440 to a water pipe or water line 535. The coupling portion 440 is a bracket, for example.

The coupling portion 440 may be configured to be coupled to an item of farm equipment 505 with any one or more of, adhesive bonding, welding or mechanical fastening, such as with one or more screws, bolts, rivets, brackets, cable ties, tie wire or straps, for example.

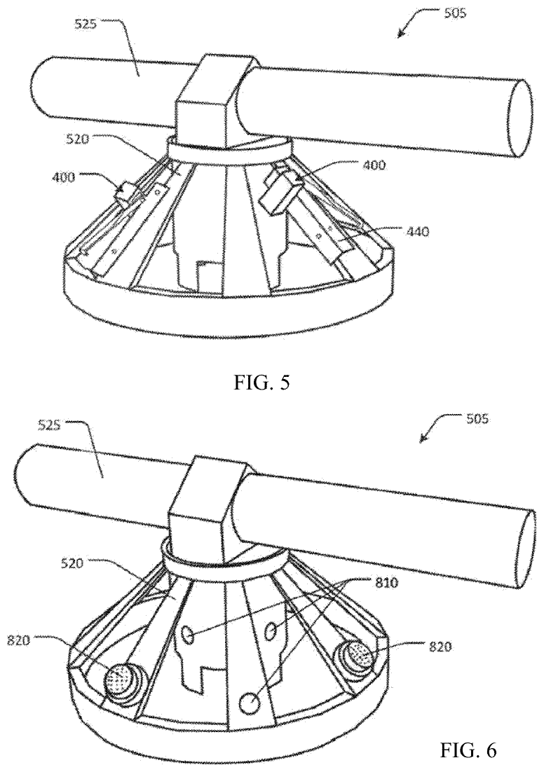

In some embodiments, the striker 410 may be configured to strike an item of farm equipment 505 to produce the auditory stimulus. For example, referring to FIG. 5, the device 400 is shown coupled to a feed outlet or feeder 520 and arranged such that the motor 420 can be operated to move the striker 410 to strike part of the feeder 520. In some embodiments, multiple devices 400 or mechanisms 405 may be coupled to an item of farm equipment 505 to contribute to the auditory and visual stimuli.

In some embodiments, the striker 410 may be configured to strike part of the supporting structure 515 or service line conduit 340, for example.

Referring to FIG. 6, in some embodiments, the auditory system 320 may comprise one or more speakers 820 configured to produce a sound in accordance with the auditory stimulus characteristics discussed earlier. The sound varies in intensity over each cycle. The visual system 310 may comprise one or more lights 810 which vary in brightness over each cycle. The speakers 820 may be configured to broadcast an audio recording. The audio recording may be of a natural mother animal of the same species as the juvenile farm animals, or an artificially produced imitation of a natural mother animal of the same species as the juvenile farm animals, or in some embodiments, a musical recording.

The lights 810 and speakers 820 may be attached to an item of farm equipment 505, as shown in FIG. 6, or may be disposed elsewhere. For example, in some embodiments, the lights 810 may comprise LEDs disposed near or attached to an item of farm equipment 505. In some embodiments, the lights 810 may comprise lasers disposed away from the farm equipment, but configured to attract juvenile farm animals to a selected location or item of farm equipment 505 by lighting the selected location or item of farm equipment 505 to contribute to the visual stimulus.

In some embodiments, the speakers 820 may be attached to or disposed near the location or item of farm equipment 505. In some embodiments, the speakers 820 may comprise directional speakers located away from the location or item of farm equipment 505 and configured to direct sound towards the location or item of farm equipment 505 to contribute to the auditory stimulus.

In some embodiments, the cycle frequency may be defined by the number of times the audio recording is repeated in a given time (e.g., per minute). In some embodiments, the cycle frequency may be defined by a frequency of a repeated cycle of similar sounds within an audio recording, such as a frequency of clucking, pecking or snorting, for example. In some embodiments, the cycle frequency may be defined by a tempo of music in the audio recording, such as the number of beats per minute, for example.

In some embodiments, the visual and/or auditory systems 310, 320 may be directed to generate the visual and/or auditory stimuli at a location away from a feed or water outlet, and then progressively adjusted to be directed towards the feed or water outlet to draw the juvenile farm animals towards the feed or water outlet.

Whether the apparatus 300 or components of the apparatus 300 are attached directly to farm equipment 505 or disposed elsewhere, the visual and auditory stimuli 310, 320 may be configured to encourage juvenile farm animals to move towards a selected location, such as a feed outlet or water outlet, for example.

In some embodiments, components of the visual and auditory systems 310, 320 may be disposed at multiple spaced locations along a water line 535 or feed line 525 having multiple water or feed outlets 530, 520 spaced along the water line 535 or feed line 525. For example, devices 400 may be spaced at 1.6 m intervals with lights 810 spaced every 0.4 m along a water line or feed line. When operated during the operating periods, the visual and auditory stimuli may attract the juvenile farm animals and encourage them to move towards the water line 535 or feed line 525, thereby increasing the probability of the juvenile farm animals eating or drinking during the operating period.

In some embodiments, the auditory stimulus may comprise a water hammer effect produced by inducing successive pressure waves in a water pipe in successive cycles of the auditory stimulus. For example, the water pipe 535 may be at or near the selected location and the vibration of the water pipe 535 may provide the auditory stimulus.

The pressure waves may be induced in the water pipe 535 by operating a pump to vary the pressure of the water in the pipe 535. One or more single or double one-way valves may be used to allow water to flow through the pipe in one direction when the pressure is increased, and suddenly restrict flow in the other direction when the pressure gradient is reversed so that the water impinges on the closed valve and creates a shock wave or pressure wave in the water that propagates along the water pipe to contribute to the auditory stimulus. The pump and valves may be operated by the control system 330 to induce the pressure waves and generate the auditory stimulus.

In some embodiments, the intensity of vibrations caused by the auditory stimulus may be sufficient to cause at least part of the apparatus 300 or farm equipment 505 to visibly oscillate, thereby providing or contributing to the visual stimulus. That is, the visual stimulus may be provided as a result of providing the auditory stimulus.

Various embodiments may be suited to different situations, such as encouraging different species of juvenile farm animals to move towards one or more selected locations to eat or drink.

The embodiments shown in FIGS. 1 to 6 may be suitable for juvenile birds or poultry, such as chicks or ducklings, for example. The visual and auditory systems 310, 320 may be configured to generate visual and auditory stimuli that mimic pecking or clucking, for example. For chicks (juvenile chickens), the cycle frequencies of both the visual and auditory stimuli may be in the range of 190 to 260 cycles per minute, 160 to 290 cycles per minute, or 60 to 350 cycles per minute. The operating periods may be in the range of 15 to 45 seconds, 10 to 60 seconds, or 5 to 120 seconds in length. The non-operating periods may be in the range of 1 to 2 minutes, 1 to 5 minutes, 5 to 15 minutes, or 1 to 30 minutes. In some embodiments, a longer non-operating period may be provided after a sequence of relatively shorter operating and non-operating periods. For example, the longer operating period may be greater than 15 minutes, greater than 30 minutes, greater than 1 hour, greater than 2 hours, greater than 4 hours, or greater than 8 hours. A longer non-operating period may be programmed for night time or another period when it is not appropriate for the juvenile farm animals to eat or drink.

Some embodiments may be better suited to other animals, such as pigs or piglets, for example. Sows use a variety of behaviours, vocalisations and physiological changes to signal to piglets that they should come and feed. Piglets also use behaviours and vocalisations to signal to sows and each other that they are hungry. The specific combination of these signals and stimuli may be mimicked by the visual and auditory systems 310, 320 to attempt to recreate the feeding cycles that naturally occur when sows feed their piglets.

Encouraging piglets to feed at an artificial food outlet in the absence of a live sow may provide a number of advantages and improve both piglet and sow welfare. It may negate the need for a sow stall, and it may allow better control and standardization of the food intake quantity for each piglet.

The food outlet for feeding piglets may comprise an artificial teat with a food valve 370 for controlling the flow of milk to the artificial teat. A plurality of artificial teats may be provided to allow a plurality of piglets to feed simultaneously. For example, the apparatus 300 may comprise between 1 and 6 teats, or at least as many teats as there are piglets to feed.

The auditory system 320 may comprise a resonance chamber with one or more membranes which are struck by a striker of a mechanism in a similar manner to that described in relation to device 400. The vibration of the membranes may also provide or contribute to the visual stimulus. In some embodiments, the auditory system 320 may comprise one or more speakers configured to broadcast an audio recording of sow snorts to generate the auditory stimulus. The auditory stimulus may cause part of the apparatus 300 or farm equipment 505 to vibrate and visibly oscillate to provide the visual stimulus. A resonance chamber with one or more membranes may be used in conjunction with the speakers to generate the visual stimulus by vibrating in response to the auditory stimulus broadcast from the speakers. In some embodiments, a separate visual system 310 may be provided to generate a corresponding visual stimulus.

The control system 330 may be configured to operate the visual and auditory systems 310, 320 and food valve 370 to provide a feeding sequence, which may be repeated a number of times each day.

Each cycle of the auditory stimulus may comprise a snort noise with a characteristic frequency or pitch in the range of 60 Hz to 250 Hz and a duration in the range of 0.1 to 2 seconds, for example.

In some embodiments, the cycle frequency of the auditory stimulus may be adjusted to different frequencies during different phases of the feeding sequence.

In a first phase of the feeding sequence, the cycle frequency may be in the range of 100 to 110 per minute, 90 to 120 per minute, 60 to 180 per minute, or 50 to 200 per minute. The duration of the first phase may be in the range of 20 to 260 seconds, 40 to 120 seconds, or 50 to 75 seconds, for example.

In a second phase of the feeding sequence, the cycle frequency may be in the range of 10 to 100 per minute, 20 to 60 per minute, or 30 to 50 per minute. The duration of the second phase may be in the range of 10 to 120 seconds, 20 to 75 seconds, or 35 to 50 seconds, for example.

During or towards the end of the second phase the piglets may show interest in the artificial milk teats. This may be indicated by piglets head-butting and nudging the teat or surrounding structures.

In some embodiments, the apparatus 300 may comprise pressure sensors or strain sensors to detect any nudging or head-butting by the piglets. The signal produced by these sensors may trigger the control system 330 to open the food valves 370 to allow increased flow of milk to the teats during feeding.

In a third phase of the feeding sequence, the cycle frequency may be irregular, and the auditory stimulus may comprise a sporadic or randomly generated series of snorts or cycles. The number of cycles in the third phase may be in the range of 1 to 20 cycles, 3 to 10 cycles, or 5 to 7 cycles, for example. The duration of the third phase may be in the range of 10 to 260 seconds, 20 to 120 seconds, or 30 to 60 seconds, for example. The piglets may begin feeding during or shortly after the end of the third phase and continue to feed for a feeding period.

Each feeding sequence may last for a period in the range of 1 to 20 minutes, 2 to 10 minutes, or 5 to 7 minutes, for example. The feeding sequence may be repeated once every 15 to 120 minutes, 30 to 60 minutes, or 40 to 45 minutes.

The control system 330 may be configured to open the food valve 370 during the feeding sequences, and close the food valve 370 in the periods between feeding sequences. The food valve 370 may be kept closed until the second phase of the feeding sequence. The control system 330 may be configured to open the food valve 370 at or near the end of he second phase. A period in which the food valve 370 is open may be less than 300 seconds, 200 seconds, 100 seconds. 60 seconds, 40 seconds, or 30 seconds, for example.

When the food valve 370 is open, the artificial milk teat may have an intra-teat pressure in the range of 10 to 20 mmHg, 5 to 25 mmHg, or 2 to 35 mmHg, for example. The intra-teat pressure may be controlled by the control system 330 via a pump and the food valve 370. In some embodiments, the control system 330 may be configured to cause the intra-teat pressure to rise at/or near the end of the second phase of the feeding sequence. The pressure rise may be in the range of 20 to 50 mmHg, 10 to 60 mmHg or 5 to 120 mmHg. The intra-teat pressure may be allowed to return to the baseline pressure during the third phase of the feeding sequence.

The auditory stimulus may be provided at the milk teat, or within a certain distance of the milk teat, such as less than 15 m, 10 m, 3 m, 2 m, 1 m or 300 mm, for example.

The cycle frequency of the visual stimulus may be equal or different to the cycle frequency of the auditory stimulus, in some embodiments, visual stimulus may be different to the cycle frequency of the auditory stimulus by a factor of 1 to 4 or 1.5 to 2.

The visual stimulus may be synchronised and in phase with the auditory stimulus or out of phase with the auditory stimulus.

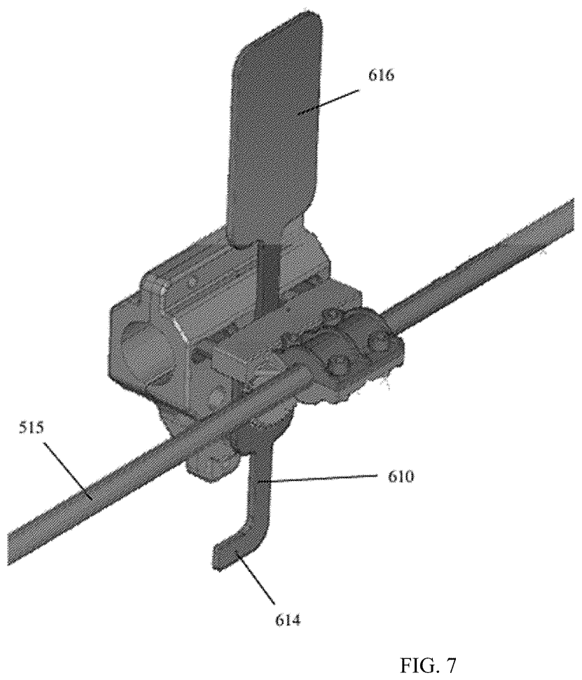

The device of the embodiment shown in FIG. 7 differs from the other embodiments in that the arc of movement created by the swing of the neck component 610 is in a plane parallel to the plane along which the support structure 515 is aligned. In some embodiments, the neck component 610 will be in the same plane as the support structure 515. Advantageously, this arrangement minimizes the risk of pinch points for the chicks. Additionally, as neck component 610 and beak component 614 swing through the arc of movement, flag 616 swings through a complementary arc of movement and is visible to chicks further away from the food/water source.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A system for increasing feed/drink attempts made by juvenile animals during an early period of life of the juvenile animals, comprising:
at least one visual stimulus, the at least one visual stimulus including
a neck member being attachable to a component of the system such that the neck member is movable with respect to the component, the neck member having an indicating portion configured to indicate a location of at least one feed/drink source,
wherein, in operation, the indicating portion repeatedly alternates between a movement toward and a movement away from the location of the at least one feed/drink source.

2. The system of claim 1, wherein the neck member has first and second opposed ends, with the indicating portion being attached to the first end and with the neck member being attached to the component of the system, and
wherein the neck member is pivotable relative to the component of the system.

3. (canceled)

4. The system of claim 1, wherein the indicating portion is configured to move through an arc in a substantially vertical plane.

5. (canceled)

6. The system of claim 1, wherein the system further includes an auditory stimulus.

7. (canceled)

8. The system of claim 1, wherein the visual stimulus further includes an enhancer extending from the neck member to enhance visibility of the visual stimulus to the juvenile animals.

9. The system of claim 1, wherein the indicating portion is provided at an angle of about 90° with respect to the neck member.

10. The system of claim 1, wherein, in operation, the indicating portion repeatedly alternates between a movement toward and a movement away from the location of the feed/drink source at a first predetermined cycle frequency, and
wherein the first predetermined cycle frequency is in a range of 60 to 180 cycles per minute.

11. (canceled)

12. The system of claim 6, wherein the system is configured to alternate between operating the visual stimulus for an operating period and halting operation of the visual stimulus for a non-operating period.

13. The system of claim 12, wherein the system is configured to alternate between operating the auditory stimulus for the operating period and halting operation of the auditory stimulus for the non-operating period.

14. The system according to claim 1, comprising a plurality of visual stimuli and a plurality of feed/drink source locations,
wherein the feed/drink sources are positioned between about 1_m and about 4_m from one another.

15. The system according to claim 14, wherein each feed/drink source location has a corresponding visual stimulus.

16. The system according to claim 6, wherein the auditory stimulus includes one or more speakers configured to produce sounds.

17. The system according to claim 16, wherein the sounds include a sequence of tones.

18. The system according to claim 17, wherein the sequence of tones comprises at least three tones.

19. The system according to claim 16, wherein the auditory stimulus is provided at a second predetermined cycle frequency.

20. A method of increasing feed/drink attempts made by juvenile animals during an early period of life of the juvenile animals using the system of claim 19, wherein the early period of life is a period in which the juvenile animals exhibit a neonate nutrient response.

21. The method of claim 20, further including adjusting the first predetermined cycle frequency in accordance with a temperament of the juvenile animals.

22. The method of claim 21, further including adjusting the second predetermined cycle frequency in accordance with a temperament of the juvenile animals.

23. The system according to claim 1, comprising one or more lights.

24. An apparatus for encouraging juvenile farm animals to feed or drink from one or more selected locations, the apparatus comprising:
a visual system configured to generate a visual stimulus;
an auditory system configured to generate an auditory stimulus; and
a control system configured to operate the visual system and the auditory system.

25. The apparatus according to claim 24, wherein the control system is configured to operate the visual system to generate the visual stimulus at a first selected cycle frequency, and
wherein the control system is configured to operate the auditory system to generate the auditory stimulus at a second selected cycle frequency.

26. The apparatus according to claim 25, wherein the first selected cycle frequency is in the range of 60 to 180 cycles per minute and/or the second selected cycle frequency is in the range of 60 to 180 cycles per minute.

27. The apparatus according to claim 15, wherein the first selected cycle frequency and the second selected cycle frequency are the same.

28. The apparatus according to claim 24, further comprising:
a system for increasing feed/drink attempts made by juvenile animals during an early period of life of the juvenile animals, comprising:
at least one visual stimulus, the at least one visual stimulus including a neck member being attachable to a component of the system such that the neck member is movable with respect to the component, the neck member having an indicating portion configured to indicate a location of at least one feed/drink source,
wherein, in operation, the indicating portion repeatedly alternates between a movement toward and a movement away from the location of the at least one feed/drink source

29. The apparatus according to claim 24, wherein each visual stimulus is generated within 30 cm of a respective selected location of one or more selected locations and/or each auditory stimulus is generated within 30 cm of the respective selected location of the one or more selected locations.

30. The apparatus according to claim 24, wherein the control system is configured to alternate between:
operating the visual and auditory systems concurrently for an operating period, and
halting operation of the visual and auditory systems for a non-operating period during which food/drink remains available to the juvenile animals.

31. The apparatus according to claim 24, wherein the juvenile animals are juvenile poultry.

32. The system according to claim 23, wherein the lights comprise LEDs.
